(19) United States
(12) Patent Application Publication
(10) Pub. No.: US 2008/0008366 A1
(43) Pub. Date: Jan. 10, 2008

(54) Simultaneous visualization, analysis and navigation of multi-modality medical imaging data

(76) Inventors: Vladimir Desh, Glenview, IL (US); Darrell Burckhardt, Hoffman Estates, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/471,216

(22) Filed: Jun. 20, 2006

(51) Int. Cl. G06K 9/00

(52) U.S. Cl. 382/128

(57) ABSTRACT

A method of combining data from multi-modality imaging to provide simultaneous processing, visualization and navigation of both functional and anatomical image information, such as, for example, in cardiac studies. Multi-modality imaging data such as SPECT, PET, CT, MRI and ultrasound are correlated and coregistered, and assembled for visualization in a number of different view formats simultaneously and in a correlated manner whereby selection of a particular area or segment from one view causes reorientation or adjustment of other views to be consistent with the selected area or segment to facilitate analysis.

### BACKGROUND OF THE INVENTION

1. Field of the Invention

The present invention relates generally to multi-modality medical imaging of a patient for diagnostic and prognostic analysis, and more particularly to improvements in processing of data obtained from different types of medical imaging devices for visualization and analysis.

2. Description of the Background Art

Medical imaging systems of a number of different imaging modalities are known. Examples of such different modalities include simple planar X-ray, X-ray Computed Tomography (CT), Single Photon Emission Computed Tomography (SPECT), Positron Emission Tomography (PET), Magnetic Resonance Imaging (MRI), and Ultrasound, among others. The particular characteristics of each modality lend themselves to particular applications.

Diagnostic imaging systems which use multiple imaging, modalities have been and continue to be developed. These multimodality systems can yield synergistic advantages above and beyond just the advantages of each specific modality. For example, it is known in the art that advantage is gained by combining SPECT and CT in a dual-modality system with each mode mounted on separate gantries with the patient supported and transported between them. Such a system allows for more accurate fusion of structural (e.g., anatomical) CT data and functional (e.g., perfusion and viability) SPECT data due to decreased patient movement.

Integrated multi-modality medical imaging systems also have recently been proposed, having one or more gamma cameras and a flat panel x-ray detector mounted on a common gantry to perform CT and SPECT studies. The gantry has a receiving aperture, a flat panel x-ray detector is mounted to rotate about the receiving aperture, and a gamma ray detector also is mounted to rotate about the receiving aperture.

Additionally, it is known to combine a PET scanner with an X-ray CT scanner in order to provide anatomical images from the CT scanner that are accurately co-registered with the functional images from the PET scanner without the use of external markers or internal landmarks. See, eg., U.S. Pat. No. 6,490,476 issued Dec. 3, 2002 to Townsend et al.

While advances have been made in imaging systems for acquisition of multi-modality imaging data, there is a need for improvement in the presentation of such data to the clinician to improve the accuracy and efficiency of defect detection or assessment accuracy. For example, in the cardiology field, SPECT and PET images are typically analyzed for perfusion and viability parameters of the different segments of the heart muscle, while CT and MR images are used to derive measurements associated with the anatomy of the heart and coronary vessels. Because of their higher resolution, morphological features derived from CT and MR images are more accurate than similar features derived from SPECT and PET images. Thus, the output set of measurements for a multi-modality cardiac workflow may include the following: Regional Perfusion Scores, Regional Perfusion Defect Extent Values, Regional Perfusion Defect Severity Values, and Regional Perfusion Reversibility Extent Values, derived from SPECT Left Ventricle (LV) images, as well as Segmental Wall Thickening, Wall Segmental Thickness, and other measurements of Global Left Ventricular function, derived from CT or MR images of the same LV. A similar approach may use PET instead of SPECT and focus on LV muscle viability instead of perfusion.

Another type of data available from CT images are direct measurements of segmented blood vessels including coronary arteries and cardiac veins. Such measurements typically include the cross-sectional area of the vessel's lumen, or the major and minor axes of cross-section of the vessel. Since many perfusion or viability defects in the human body, such as cardiac perfusion or viability defects, brain perfusion defects, etc. are associated with atherosclerotic lesions in the associated blood vessels, such measurement data may be used to improve defect detection or assessment accuracy.

### SUMMARY OF THE INVENTION

The present invention provides a method of combining data from multi-modality imaging to provide simultaneous processing, visualization and navigation of both functional and anatomical image information, such as, for example, in cardiac studies. Thus, clinical interpretations of ill-defined cardiac defects or defects of only borderline statistical significance could be considered in light of pre-test probabilities of coronary artery disease. The pre-test probability could determine the predictive accuracy of a test interpretation in accord with Baye's theorem, which relates post-test likelihood of disease to pre-test likelihood combined with the test results. Here, the findings of supporting studies together with the results from another study could increase overall accuracy of the diagnosis. For example, one of the measures of pre-test probability of coronary artery disease in NM studies could be the calcium scores for calcified plaques obtained from CT coronary images. If a perfusion defect was demonstrated from a SPECT analysis, but only of borderline statistical significance, the presence of coronary artery disease would not be indicated if the corresponding calcium score were low. This approach would be similar to using Framingham scores, which rely on the patient's age, blood pressure, cholesterol levels, presence of diabetes mellitus and left ventricle hypertrophy, but can be more precise as it is based on the actual test results.

### BRIEF DESCRIPTION OF THE DRAWINGS

FIG. 1 is a perspective view of scanner for nuclear medical imaging;

FIGS. 2(a) and 2(b) are decision making trees for irreversible and reversible perfusion defect use case in conjunction with the invention, respectively;

FIG. 3 is a decision making tree for an infarction use case in conjunction with the invention;

FIG. 4 is a decision making tree for a cardiac defect and coronary artery calcification score use case in conjunction with the invention; and

FIG. 5 is a view of a multi-modality multiple view map in accordance with the invention.

### DETAILED DESCRIPTION OF THE EXEMPLARY EMBODIMENTS

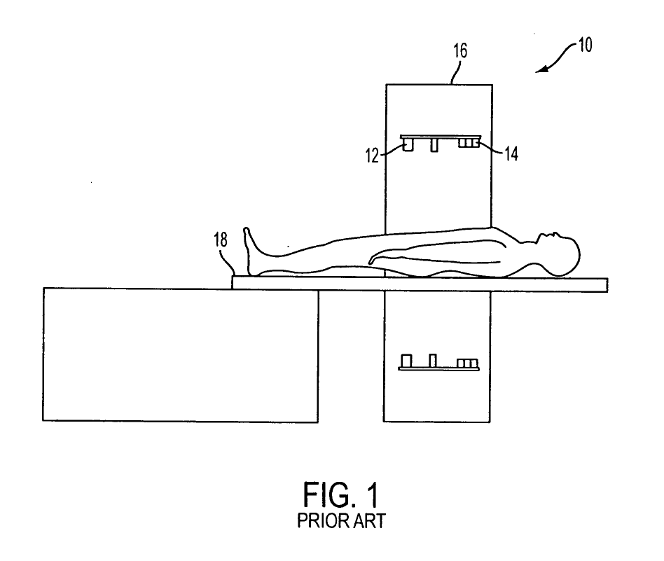

FIG. 1 shows one example of a multi-modality imaging system in the form of a combined PET and X-Ray CT scanner apparatus 10 that allows registered CT and PET image data to be acquired sequentially in a single device, which is applicable to the methods of the present invention. Similar configurations could be used for other combinations of imaging modalities, such as SPECT/CT, SPECT/MR etc.

In the example of FIG. 1, the PET/CT scanner 10 combines a Siemens Somatom spiral CT scanner 12 with a rotating PET scanner 14. The PET/CT scanner 10 includes a PET scanner 14 and a CT scanner 12, both commercially-available, in a physically known relationship one with the other. Each of the X-ray CT scanner 12 and the PET scanner 14 are configured for use with a single patient bed 18 such that a patient may be placed on the bed 18 and moved into position for either or both of an X-ray CT scan and a PET scan.

As shown, the PET/CT scanner 10 has X-ray CT detectors 12 and PET detectors 14 disposed within a single gantry 16, and wherein a patient bed 18 is movable therein to expose a selected region of the patent to either or both scans. Image data is collected by each modality and then stored in a data storage medium, such as a hard disk drive, for subsequent retrieval and processing.

The novel concepts and features of the invention will be hereinafter described with respect to cardiac studies for explanatory purposes; however it will be appreciated that the invention is not limited to cardiac studies but is applicable equally to other types of studies, including brain, lungs, etc.

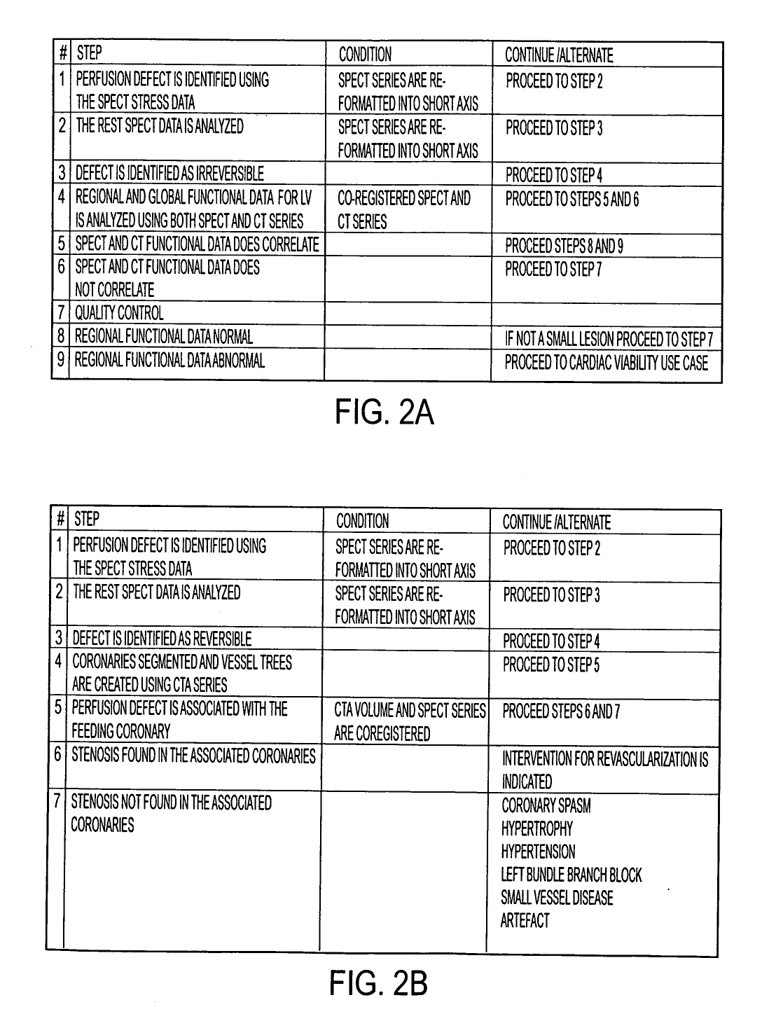

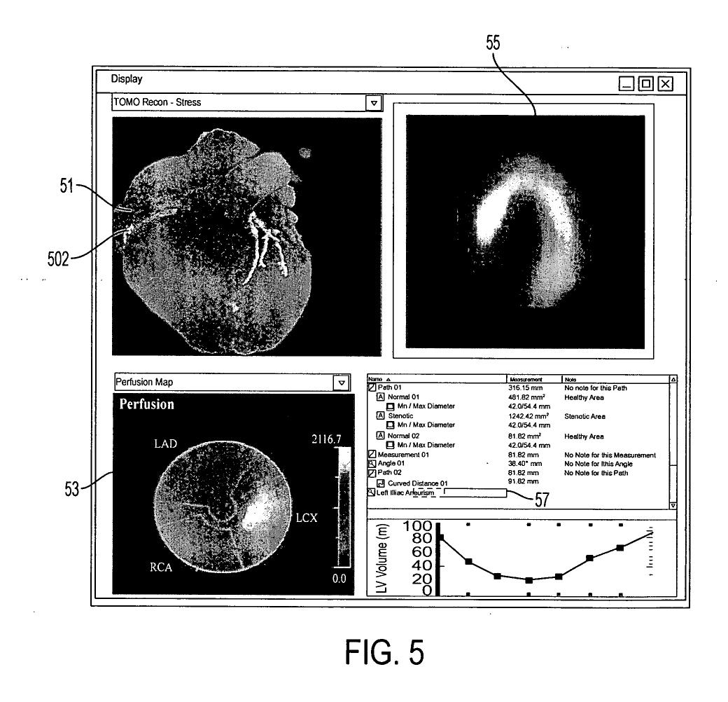

FIGS. 2(a)-2(b), 3 and 4 illustrate decision-making tree maps for various cardiac diseases such as ischemia, coronary artery disease, and infarction, respectively. These decision trees can be supported by an application for simultaneous processing and visualization of multi-modality data as shown in FIG. 5.

As shown in FIG. 5, one of the components of such application is a fused VRT (Volume Rendered Three-dimensional) display 51. VRT display 51 may display up to three volumetric objects in a fused volume rendered view. In the example, the VRT display 51 accepts three volumes: NM (ie., PET or SPECT), CT or MR. Display 51 additionally accepts segmented coronary image data 502. The segmented coronary object is a binary mask derived from a CT or MR anatomical volume. The segmented coronaries can be displayed in either a single color, or in three colors (one for each of the major vessels). The color-coding scheme can be controlled externally. Further, by modifying fusion ratios, a user can visualize fused NM/CT volumes, NM/Coronaries volumes, CT/Coronaries volumes, or all three (NM/CT/Coronaries) together. The transparency of each volume also can be controlled externally.

Another component of such application is a Polar Map 53 derived from SPECT or PET perfusion or viability studies. Polar Maps are used for visualization of Regional Perfusion (Viability) Scores, Regional Perfusion Defect Extent Values, Regional Perfusion Defect Severity Values, and Regional Perfusion Reversibility Extent Values as derived from SPECT or PET LV images, and Segmental Wall Thickening, Wall Segmental Thickness and other measurements of Global Left Ventricular function as derived from CT or MR images of the same left ventricle.

Cardiac motion in Segmental Wall Thickening Polar Maps can be derived from PET/SPECT as well as CT or MR cardiac gated studies. In this regard, access to LV motion visualization can be obtained at the option of the user from either modality of acquired data. In addition, Polar Map 53 can be used as a quality control measure, e.g., low correlation between maps can indicate the existence of data corruption.

Cross-sectional fused images 55 of multi-modality data also are shown in the display of FIG. 5. Additionally, results of measurements, such as measurements performed on the coronary vessels such as lumen diameter, calcified plaque burden, etc. are displayed in the form of a tree graph 57, associating main coronary arteries and their measurements.

Navigation through the Polar Maps 53, VRT displays 51, and tree graphs 57 is correlated according to an embodiment of the present invention. In particular, when a segment or area of the Polar Map 53 is selected (such as by clicking with a pointing device), the associated VRT object orientation is adjusted so that the corresponding area of the object (e.g., the heart) is moved to the front of the display view. The main purpose of this operation is to provide the user with the ability to match perfusion/viability/motion defect characteristics of the selected area of the Polar Map with the corresponding coronary vessel(s) 502 supplying blood to that area, as visualized on the VRT display 51.

Further, when a user selects a certain measurement from the tree graph 57 (again, such as by clicking with a pointing device), such as a calcified plaque measurement, the VRT object 51 orientation is adjusted such that the user is able to observe the corresponding vessel segment, together with corresponding perfusion or viability information pertaining to the selected measurement, as displayed by an associated Polar Map 53.

The cross-sectional images 55 can be oriented such that they are orthogonal to a selected vessel segment. This will allow a user to assess a degree of stenoses. One benefit of this feature is that users will be able to observe calcified plaques as well as vulnerable plaques marked by increased FDG uptake on PET images. Alternately, fused MPR images may be displayed at predetermined or arbitrary heart orientations.

Referring to the decision-making maps of FIGS. 2(a)-2(b), 3 and 4, these are basically self-explanatory. Consequently, the example of FIGS. 2(a)-2(b) only will be further discussed herein for purposes of illustration. FIG. 2(a) shows an example where a user diagnoses an irreversible perfusion defect. At step 1, SPECT stress data (e.g., in the form of a Polar Map 53) is analyzed and a perfusion defect is identified. SPECT rest data is then displayed and analyzed at step 2, whereby at step 3, the defect is preliminarily identified as irreversible. Next, at step 4, regional and global left ventricle functional data are analyzed using coregistered SPECT and CT series data (e.g., as shown by VRT display 51 and/or cross-sectional data 55). If at step 5, the SPECT and CT data do correlate and the regional functional data is normal (step 8), then a quality control confirmation is performed (step 7) if the observed lesion is not small. If at step 9 it is determined that the regional functional data is abnormal, then a cardiac viability use case (see FIG. 4) is executed. If on the other hand, the SPECT and CT data do not correlate (step 6), then a quality control confirmation is performed at step 7 to confirm the existence of data corruption.

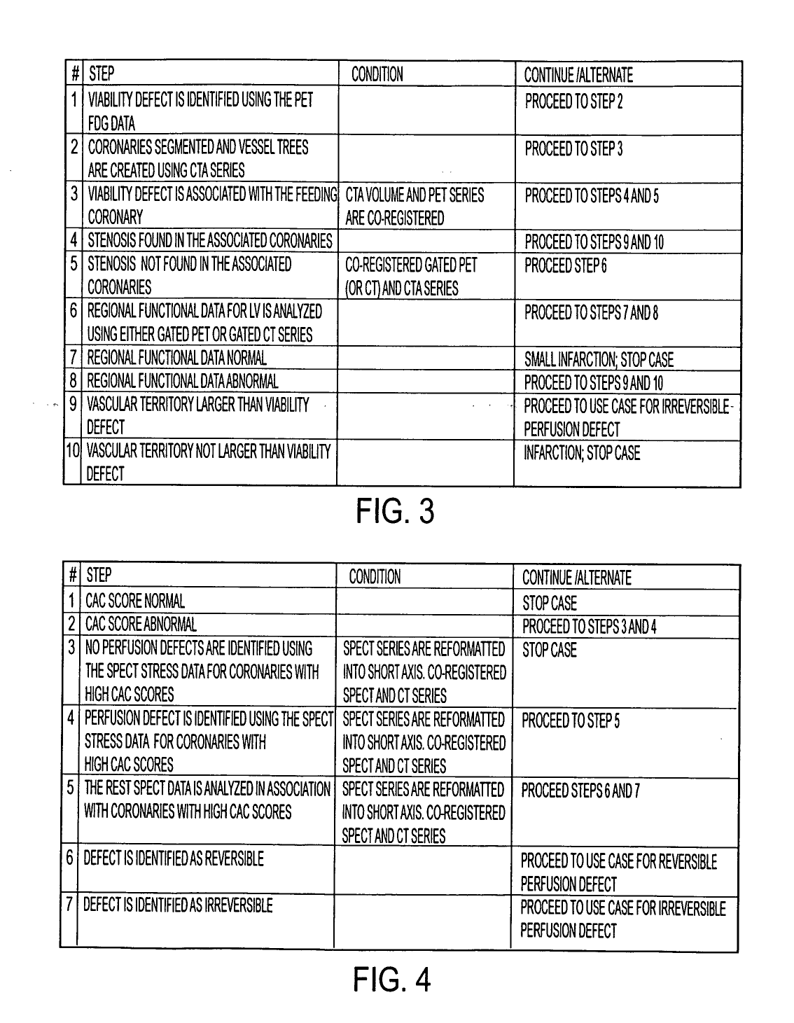

FIG. 2(b) illustrates the case for a reversible perfusion defect. Steps 1 and 2 are the same as for FIG. 2(a). At step 3, the defect is preliminarily identified as being reversible. Then at step 4, coronary segments (502) are created and vessel trees (57) are created using CTA series data. As a result, at step 5, the perfusion defect is associated with the supply or feeding coronary (wherein the CTA volume and SPECT series data are coregistered on the display). If at step 6 a stenosis is found in the associated coronaries, then an indication for revascularization is prescribed. If at step 7 no stenosis is found in the associated coronaries, then possible diagnoses might include coronary spasm, hypertrophy, hypertension, left bundle branch block, small vessel disease, or artifact. The use cases shown in FIGS. 3 and 4 are analogous to the cases described above and are self-explanatory. Accordingly, they will not be further discussed here.

As will be apparent from the above disclosure, the present invention provides a method for simultaneous analysis and visualization of multi-modality imaging data whereby different forms of data acquired for a particular patient study are combined and correlated on a simultaneous display, such that simultaneous processing, visualization and navigation through different sets of data and different views is made possible. The invention thus provides significant benefits to professionals such as nuclear medicine cardiologists, radiologists, and internal medicine practitioners of improved diagnostic efficiency and accuracy for studies concerning organs such as the heart, brain, lungs, prostate gland, etc.

While the invention has been described in detail above, the invention is not intended to be limited to the specific embodiments as described. It is evident that those skilled in the art may now make numerous uses and modifications of and departures from the specific embodiments described herein without departing from the inventive concepts.

What is claimed is:

1. A method for presentation of multi-modality medical imaging data to a user, comprising the steps of:
correlating data from a plurality of different imaging modalities concerning a particular object;
assembling said data into a plurality of different views on a display;
allowing particular areas or segments of said data in at least one of said views to be selected; and
in response to said selection, reorienting or adjusting the other views of said plurality of different views so as to correspond to said selected areas or segments.

2. The method of claim 1, wherein said different imaging modalities are selected from the group consisting of SPECT, PET, MRI, CT, and ultrasound.

3. The method of claim 1, wherein said step of correlating comprises the step of co-registering multi-modality data to enable the display of fused images.

4. The method of claim 3, wherein said fused images comprise VRT images.

5. The method of claim 3, wherein said fused images comprise MPR images.

6. The method of claim 3, wherein said fused images comprise cross-section fused images.

7. The method of claim 1, wherein the step of assembling comprises the step of developing a VRT image.

8. The method of claim 1, wherein the step of assembling comprises the step of developing a Polar Map image.

9. The method of claim 1, wherein the step of assembling comprises the step of developing a measurement tree graph.

10. The method of claim 1, wherein the step of allowing particular areas or segments of said data in at least one of said views to be selected comprises the step of accepting input from a pointing device.

11. The method of claim 1, wherein the step of allowing particular areas or segments of said data in at least one of said views comprises allowing selection in at least a VRT view, a Polar Map view, a tree graph view, or a cross-sectional fused view.

12. A system for presentation of multi-modality medical imaging data to a user, comprising:
a display for displaying a plurality of different views of multi-modality imaging data on a display;
said multi-modality data being correlated from a plurality of different imaging modalities concerning a particular object;
a mechanism for allowing particular areas or segments of said data in at least one of said views to be selected; and
a mechanism responsive to said selection for reorienting or adjusting the other views of said plurality of different views so as to correspond to said selected areas or segments.
